(19) United States
(12) Patent Application Publication
(10) Pub. No.: US 2015/0116485 A1
(43) Pub. Date: Apr. 30, 2015

(54) DEVICE TO SHADE PERSONS FROM BRIGHT SUNSHINE, DYNAMICALLY FROM LARGE HEIGHT BY MATCHING SHADE PATTERN TO PRESENCE

(71) Applicant: Krishna Prasad Panduranga Revankar, Bangalore (IN)

(72) Inventor: Krishna Prasad Panduranga Revankar, Bangalore (IN)

(73) Assignee: Hemang Subramanian, Atlanta, GA (US)

(21) Appl. No.: 14/392,005

(22) PCT Filed: Jul. 4, 2013
(86) PCT No.: PCT/IN2013/000412

§ 371 Date: Jan. 5, 2015

(30) Foreign Application Priority Data
Jul. 4, 2012 (IN) 2689/CHE/2012
Jul. 4, 2012 (IN) 2690/CHE/2012
Jul. 25, 2012 (IN) 3042/CHE/2012
Jul. 25, 2012 (IN) 3044/CHE/2012
Jul. 25, 2012 (IN) 3045/CHE/2012

(51) Int. Cl. E04H 15/02; G06K 9/00; G05D 3/00; G05B 15/02; G05D 7/06

(52) U.S. Cl. CPC E04H 15/02; G05B 15/02; G05D 7/0635; G05D 3/00; G06K 9/00724; G06K 9/00369
USPC 348/135; 700/283

(57) ABSTRACT

A device, system and method of shading person large open area from large height without obstruction to view, work and play by matching shade pattern formed by shading unit for the given sun position and the location of the person on land and building, by means of shading units moved by control from computer and by manual control and providing local cooling by directed, pulsed cold air jet. Shading unit supported by cables and at periphery shading unit on cantilever based support is used and for small areas. The above devise and system is to protect people from occupational and environmental harmful effect of bright sunshine causing skin cancers and allergy and which so far has been tolerated quietly by people involved in sports, construction, agriculture, sea rigs, and recreation in beach.

### CLAIMS OF PRIORITY

This patent application claims priority from the Provisional Patent Application No. 2689/CHE/2012 and No 2690/CHE/2012 filed on 4 Jul. 2012. It also claims priority from Provisional patent applications No 3042/CHE/2012, No 3044/CHE/2012 and No 3045/CHE/2012 filed on 25 Jul. 2012.

### FIELD OF TECHNOLOGY

This disclosure relates generally to technical fields of Occupational Health protection from sun light, and comfort, involving mechanism and computer, and in one embodiment to a device to shade a person in large open space, from a height by means of shading units moving at large height in synchrony with the movement of the person.

### SUMMARY

A device, system, and method to provide shade from bright sunshine from large height, by means of shading units which moves in synchrony with a person, a animal to be shaded and synchronized with the angle of solar radiation so that the place where the person is present is always shaded and additionally cool air applied to small local area by directed pulsed air jets, is disclosed. In one aspect, the device addresses the problem of occupational hazard from bright sunshine for people working in large open spaces, involved in sports, in recreation at beach etc, leading to long periods of exposure to sun and especially professional players with long practice sessions. The devise is a recreation enabler in sports for corporate executives for whom hot sunshine and high temperature is a disincentive and discouraging and this device allows full utilization of stadiums when not having tournaments.

In another aspect, the prior art has shading structures covering entire stadium which is expensive to build and the natural effect of open sun light is obstructed and diminished. The present invention maintains the beautiful natural effect of sunlight. Prior art has devises wherein hydrogen balloons tied by string to the person to be shaded from small height, but this obstructs the activity and the view of spectators. People have thought of large artificial cloud and shading structures held by helicopters to shade from great height but this is going to be expensive and consumes high power and also high noise level, aerodynamic stability and safety problems especially when large crowds are present below. Air conditioning of entire stadium is very expensive and a power guzzler. The present invention is low on infrastructure cost and low on power consumption compared to prior art while still giving the comfortable condition for work and play in the most economical and compact manner.

Prior art quoted by preliminary search authority under PCT being general state of art, are US 2011315811 A1 where a lighter than air vehicle is used for shading and has the problem of wind management as wind effects increase with size and air vehicle has low maneuverability and serious safety problem for persons below on ground in case of the unit or a component falling off from large height and does not involve dynamic matching of person to be shaded with the position of the air vehicle. The Japanese patent quoted being JP 2008212421 A uses flying shading unit to shade a person does not use cameras to capture the fast changing position of the person and does not synchronize shading unit with anticipated movement with manual support where necessary, as required in a sport event and also does not correct the problem due to wind specially when shading unit is at large height and has no feedback of shading unit position error. The other quoted patent U.S. Pat. No. 2,693,230 being general state of art. The present invention over comes the problems in the prior art.

The matching of the pattern of shade in small-required area to the pattern of location of person dynamically within required time as in sport event using image of person being shaded and image of shading unit for feedback and correction with wind management and particularly since the shading unit is small and is located at large height, the pattern matching is the inventive major step in working of the device. The use of aerodynamic control for the shading unit and split arrangement of film in shading unit is the most essential ingredient for the proper working of the device since it is at large height and subject to wind. Drive for the shading unit is one by means of cable and one by on board electric motor and one by compressed air jet. The suspension of shading unit is by cable, which is ideal for most continuous use conditions. For rapid and urgent deployment, the shading unit with propeller drive to lift and move, having a single cable wire to supply electrical power to the propeller drive motor, is used in spite of difficulty in stabilization under windy condition. The presence of flexible and light structure of shading unit is essential for safety, using water filled rubber bags for counter weight in cantilever suspension, along with safety cable to hold the unit.

The plurality of camera capture position coordinates of the person to be shaded selected with distinguishing color of dress and tag when attached, based on the coordinates of person to be shaded, the right shading unit is selected as per deployment plan and shading unit is moved to the required position calculated, thereafter the persons location is tracked and predicted by software by extrapolation and velocity calculation and where needed predicted by the help of operator who sees image on monitor screen and moves cursor pointer from his experience and direction of movement of the person, taking into account sharp changes in direction as it occurs.

The scope of the invention extends to workers in construction site and agricultural farms and sea rigs, where wearing full clothing to cover in hot humid weather will be uncomfortable due to sweat accumulation and resulting uneasiness, so when shaded by the device dynamically the uncomfortable itching sensation is not there leading to improved productivity of work. Tourists in beach specially in tropical areas can enjoy the beach side at any time of the day of their choice due to the shading device. The device allows horse racing to be conducted even in hot countries. No where in the world is present a shading system as of the sort of above device in any sports stadium where the shade pattern follows the location of the player. It is surprising, by looking at old to present books on sports and open space activities, the way people have been tolerating blazing sun through out history with some relief from hat and umbrella where fast activity is not involved. It is unfair that sports heros are being subjected to hot sun while the spectators of sports sit under shaded comfort. People with sun allergy will benefit from the device. Women who generally avoid sunshine to protect their fair white complexion can participate in sports.

The device, systems, and methods disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation, in the figures of the accompanying drawings, in which like references indicate similar elements and in which:

FIG. 1 is a aerial view of stadium with dynamic shading devise showing stadium with shading units at large height, according to one embodiment.

FIG. 2 is a view of person in shaded zone, with shade from shading unit, according to one embodiment.

FIG. 3 is a cross section view of shading unit, cable drive, positioning and aerodynamic wind control cable, according to one embodiment.

FIG. 4 is shading unit having slot with flap for wind management, according to one embodiment.

FIG. 5 is a shading unit with cantilever arm suspended from supporting cable, according to one embodiment.

FIG. 6 is a Cantilever arm with shading unit near border and camera unit on gimbal mounting, according to one embodiment.

FIG. 7 is a shading unit with propeller drive and buoyancy balloon, according to one embodiment.

FIG. 8 is a shading unit with on board motor drive and remote radio receiver according to one embodiment.

FIG. 9 is a shading unit with pneumatic drive, according to one embodiment.

FIG. 10 is a cross section view of double layer based shading unit, according to one embodiment.

FIG. 11 is a side view of double layer based shading unit, according to one embodiment.

FIG. 12 is a system view of a multiple cable spool drive, according to one embodiment.

FIG. 13 is a system view of entire device for race course for horses, according to one embodiment.

FIG. 14 is a system view of dynamic shading with cantilever unit at curves, according to one embodiment.

FIG. 15 is a system view of entire device on the beach with floating towers based cable hold, according to one embodiment.

FIG. 16 is a system view of entire device for shading construction workers, according to one embodiment.

FIG. 17 is a system view of dynamic shading of workers at road under construction, according to one embodiment.

FIG. 18 is a view of pulsed cold air pipe line with rotating popup nozzle, according to one embodiment.

FIG. 19 is a view of cold air nozzle with rotation drive motor and retraction solenoid, according to one embodiment.

Other features of the present embodiments will be apparent from the accompanying drawings and from the detailed description that follows.

### DETAILED DESCRIPTION

A device, system, and method to provide shade from bright sunshine from large height, in one embodiment about 100 feet from ground, by means of shading units which move in synchrony with the movement of person, animal to be shaded and the angle of solar radiation so that the place where the person is present is always shaded, is disclosed. Although the present embodiments have been described with reference to specific example embodiments, it will be evident that various modifications and changes may be made to these embodiments without departing from the broader spirit and scope of the various embodiments.

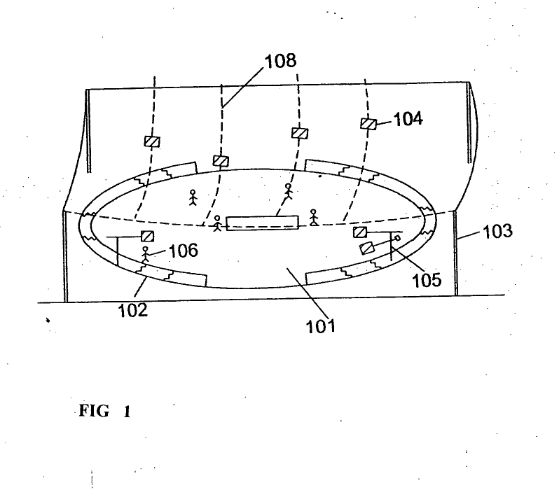

FIG. 1 is a aerial view of stadium with dynamic shading devise showing stadium with shading units at large height, according to one embodiment. Particularly, FIG. 1 illustrates a stadium 101, spectator gallery 102, cable tower 103 which is taller than floodlights generally used in stadium, shading unit 104 present at a high level, cantilever arm with shading unit near border 105, player who is shaded 106, the bright sun 107, and cable of shading unit 108, according to one embodiment.

In example embodiment, the shading units do not obstruct the view of spectators

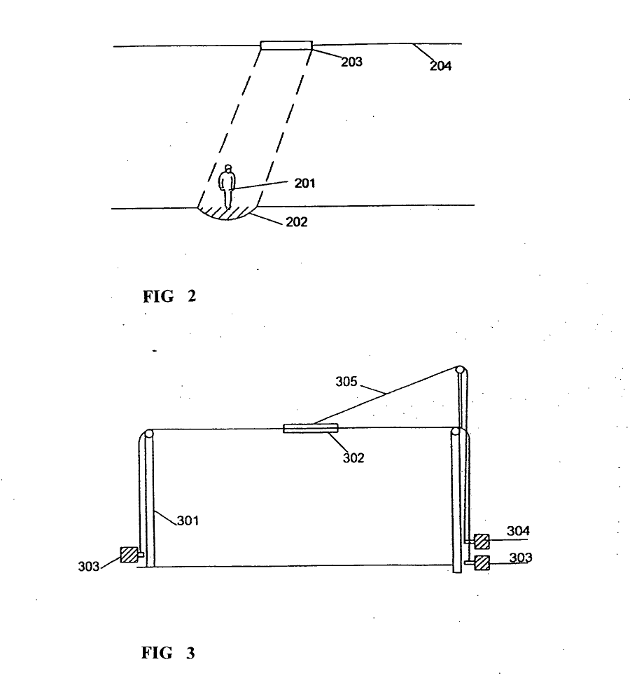

FIG. 2 is a view of a person in shaded zone, according to one embodiment. Particularly, FIG. 2 illustrates the shading unit at large height which moves to a position calculated based on the suns angular position in such a way that the shade forms a zone around the person 201 who has no need to wear a cap, the shaded zone 202, a shading unit 203, cable of shading unit 204, the sun 206, according to one embodiment.

FIG. 3 is a cross section view of shading unit, cable drive and aerodynamic wind control cable, according to one embodiment. Particularly FIG. 3 illustrates the cable tower 301, shading unit 302, electric motor with cable spool 303, electric motor for wind control cable 304, wind control cable 305.

The cable spools and drive motor in case of stadium is on the roof of spectator gallery.

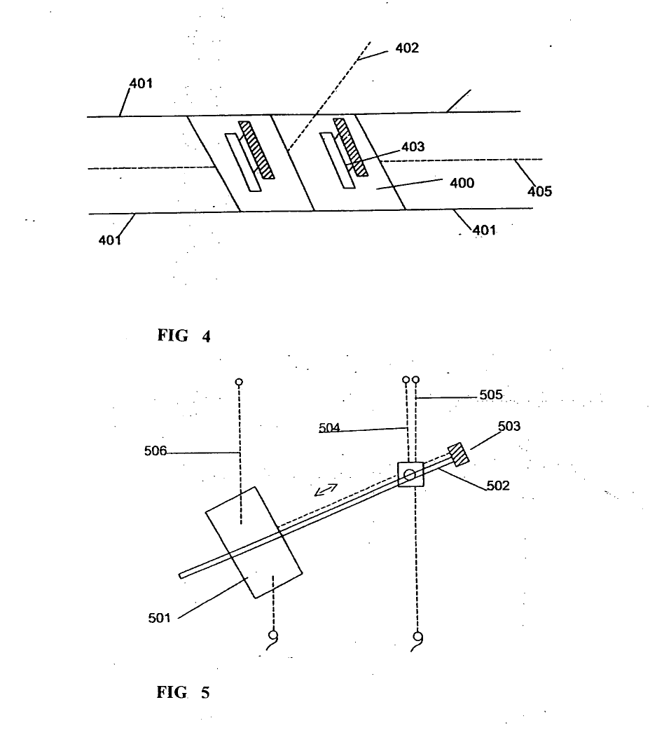

FIG. 4 is a shading unit having slot with flap for wind management, according to one embodiment. Particularly, FIG. 4 illustrates a shading unit 400, support cable of the shading unit 401, cable for wind control 402, slot 403 to equalize pressure on both sides over which sits flap, drive cable for the shading unit 405, according to one embodiment.

FIG. 5 is a shading unit with cantilever arm suspended from supporting cable, according to one embodiment. Particularly, FIG. 5 illustrates the shading unit which moves on the cantilever arm 501, cantilever arm 502, counter weight 503 made of water filled rubber bag, supporting cable 504, cable for movement and rotation of arm 505, control and stabilizer cable for shading unit 506, according to one embodiment.

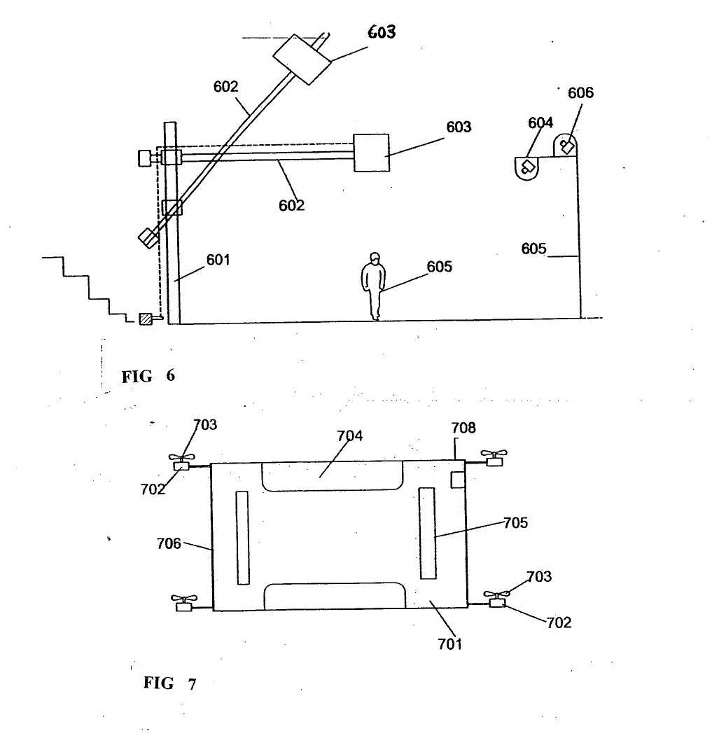

FIG. 6 is a cantilever arm with shading unit near border and camera unit on gimbal mounting, according to one embodiment, Particularly, FIG. 6 illustrates the tower 601, cantilever arm 602, shading unit 603, camera unit on gimbal 604 for getting persons location coordinates, and shading unit position for feedback, pole for fixing camera unit 605, drive cable for shading unit 606, electric drive motor 607, person shaded 608 according to one embodiment.

The rotation of cantilever arm and movement of shading unit is by means of electric motor controlled by computer.

FIG. 7 is shading unit with propeller drive and buoyancy balloon, according to one embodiment. Particularly, FIG. 7 illustrates the shading unit 701, electric motor for driving propeller 702, propeller 703, buoyancy balloon with hydrogen gas 704, slot with flap for wind pressure reduction 705, frame 706, power and control signal cable 707, micro controller for propeller and motor control 708, according to one embodiment.

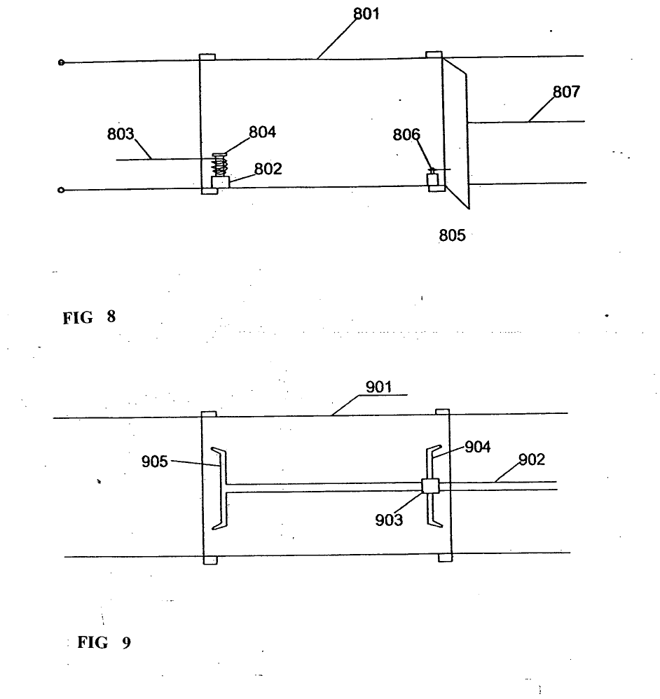

FIG. 8 is shading unit with on board motor drive and remote radio receiver according to one embodiment. Particularly, FIG. 8 illustrates the shading unit 800, frame 801, electric motor 802 to move shading unit by winding in cable 803 on spool 804, flap for wind management and control of shading unit 805, flap moving electric motor with cable 806, radio control receiver with microprocessor 807, according to one embodiment.

FIG. 9 is a shading unit with pneumatic drive using compressed air, according to one embodiment. Particularly, FIG. 9 illustrates the shading unit 901, flexible hose pipe for compressed air 902, control valve 903, nozzles 904 and 905, according to one embodiment.

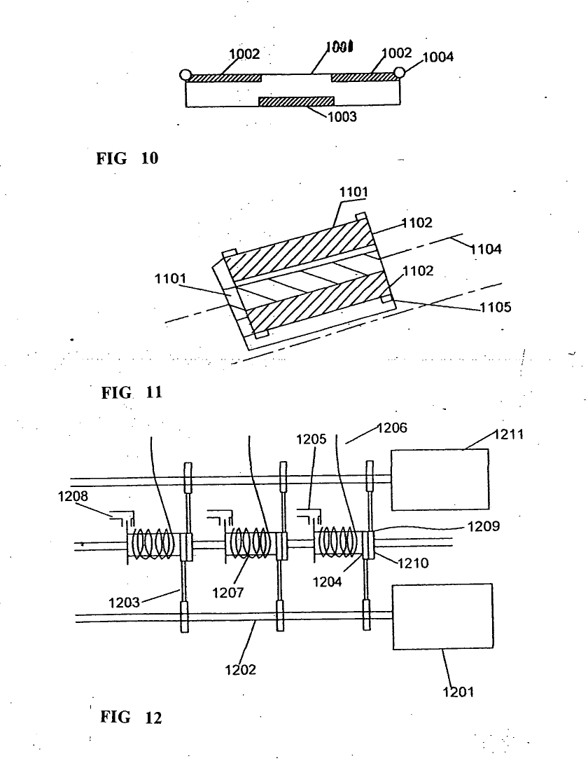

FIG. 10 is a cross section view of double layer based shading unit, according to one embodiment. Particularly, FIG. 10 illustrates the frame 1001, upper layer film 1002, lower layer film 1003, suspender through which the support cable passes 1004, according to one embodiment.

This arrangement is mainly to manage wind.

FIG. 11 is a a side view of double layer based shading unit, according to one embodiment. Particularly, FIG. 11 illustrates frame 1101, upper layer film 1102, lower layer film 1103, drive cable 1104, wind control cable 1105, according to one embodiment.

FIG. 12 is a system view of a multiple cable spool drive, according to one embodiment. Particularly, FIG. 12 illustrates the drive motor 1201 for forward drive, shaft 1202, belt drive 1203, clutch unit 1204 for forward drive, brake and hold unit 1205, drive cable 1206 on spool 1207, brake control cable 1208 and clutch control cable 1209 both operated by solenoids controlled by computer, clutch for reverse drive 1210, drive motor 1211 for reverse drive, according to one embodiment.

The actuate and de actuate timing of the clutch and brake is calculated by the computer based on the position needed for shading unit. The cable spool at one end winds up while the cable spool at other end unwinds.

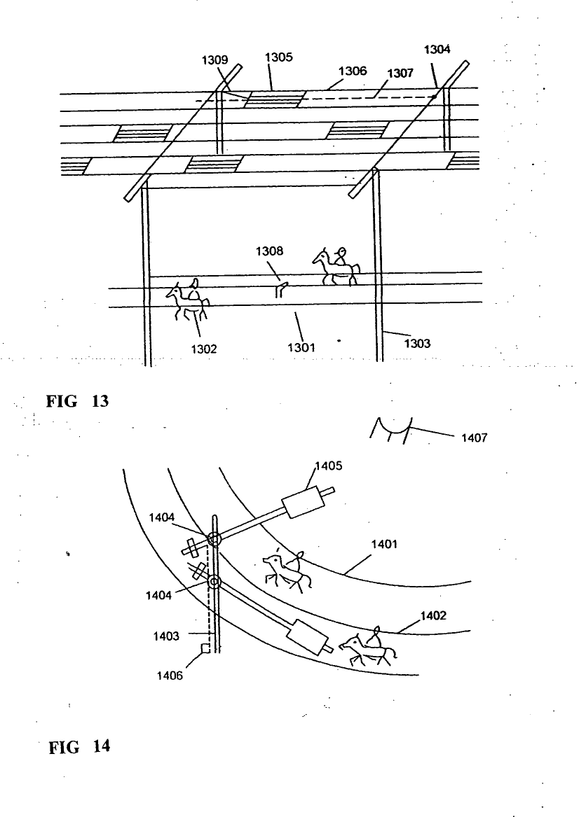

FIG. 13 is a system view of entire devise for race course, according to one embodiment. Particularly, FIG. 13 illustrates the race course with horse track 1301, horse with rider 1302, tower at border 1303, main support cable 1304, shading unit 1305, support cable for shading unit 1306, drive cable of shading unit 1307, cool air dispenser 1308, wind control cable of shading unit 1309, the bright sun 1310, according to one embodiment.

FIG. 14 is a system view of dynamic shading with cantilever unit at curves, according to one embodiment. Particularly, FIG. 14 illustrates the horse track at curve 1401, horse with rider 1402, tower for cantilever 1403, cantilever 1404, shading unit 1405, electric motor with cable drive for shading unit 1406, the bright sun 1407, according to one embodiment.

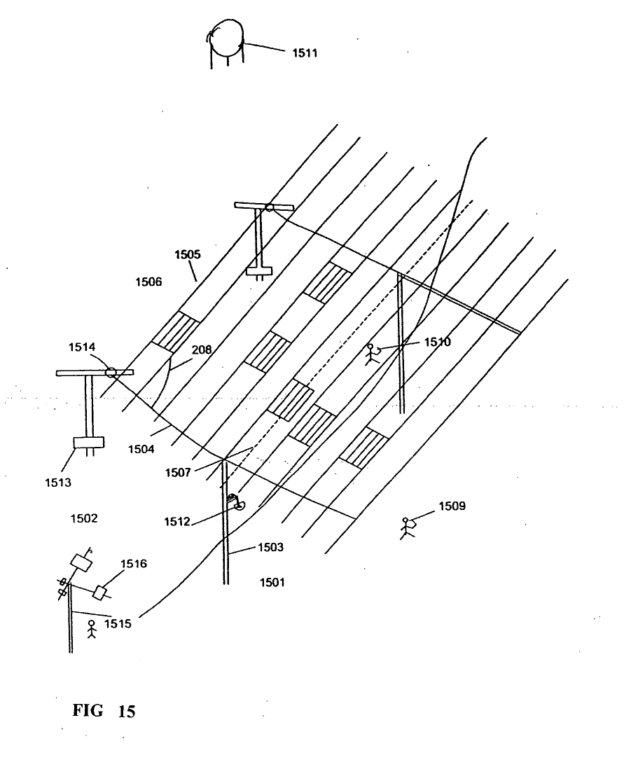

FIG. 15 is a system view of entire devise on the beach with floating towers based cable hold, according to one embodiment. Particularly, FIG. 15 illustrates the beach 1501, the sea 1502, tower near sea front 1503, main support cable 1504, support cable for the shading unit 1505, shading unit 1506, drive cable for shading unit 1507, wind control cable of shading unit 1508, person on beach 1509, person in the sea 1510, the bright sun 1511, camera on gimbal 1512, floating platform with tower 1513 anchored by cables to sea floor, tower arm holding the cable end support with sliding clutch 1514 to which the main support cable is connected, according to one embodiment.

The person on Beach to be shaded is identified by unique color tag.

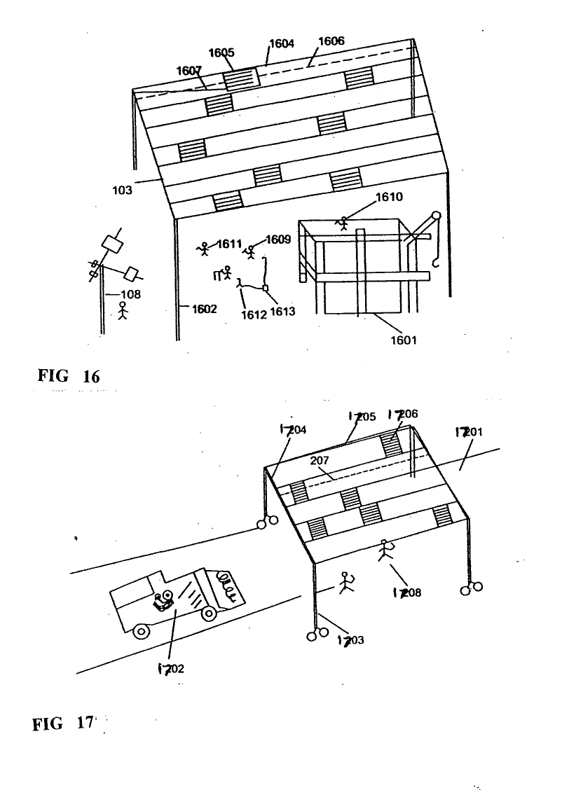

FIG. 16 is a system view of entire devise for shading construction workers, according to one embodiment. Particularly, FIG. 16 illustrates the building under construction 1601, tower to hold cables 1602, main support cable 1603, support cable for suspension of shading unit 1604, shading unit 1605, drive cable of shading unit 1606, wind control cable of shading unit 1607, cantilever unit at border 1608, worker on the ground 1609, worker on roof 1610, the manager on ground 1611, cool air pulsed jet dispenser 1612, air cooler and pump unit 1613, the bright sun 1614, according to one embodiment.

The device is most useful to workers on oil rigs and large ship platform where weather condition is very harsh.

FIG. 17 is a system view of dynamic shading of workers at road under construction, according to one embodiment. Particularly, FIG. 17 illustrates the road being constructed 1701, road paving by one of asphalting machine 1702, tower with wheel base to allow shifting of the devise 1703, main support cable 1704, support cable for shading unit 1705, shading unit 1706, cable drive for shading unit 1707, the worker 1708, the bright sun 1709, according to one embodiment.

The towers are mounted on wheels for mobility

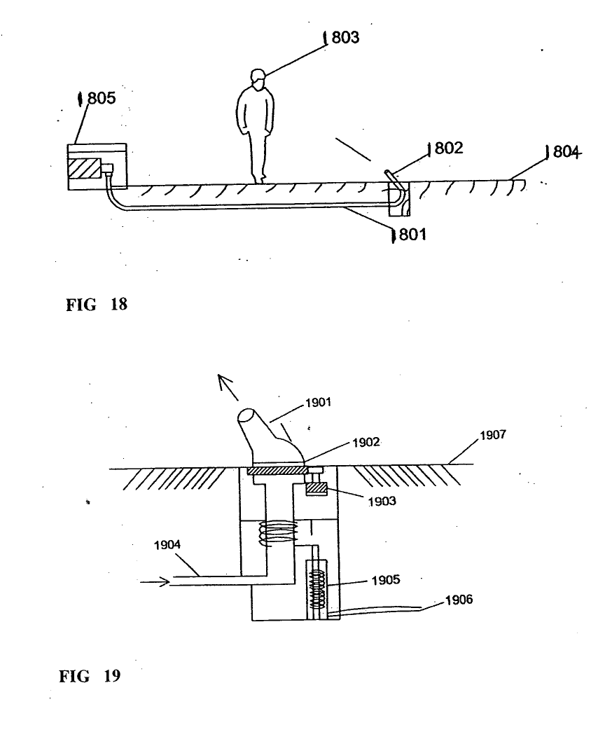

FIG. 18 is a view of pulsed cold air pipe line with rotating popup nozzle, according to one embodiment. Particularly, FIG. 18 illustrates the cold air supply pipe 1801, nozzle 1802, person provided with cool air 1803, ground 1804, air cooler and pump along with storage tank 1805, according to one embodiment.

FIG. 19 is a view of cold air nozzle with rotation drive motor and retraction solenoid, according to one embodiment. Particularly, FIG. 19 illustrates the nozzle 1901, swivel joint 1902, rotation drive electric motor 1903, cold air supply pipe line buried in ground 1904, retracting solenoid 1905, power supply cable and control signal cable 1906, ground 1907, according to one embodiment.

The area where the person is present only is locally cooled by pulsed air jets.

Although the present embodiments have been described with reference to specific example embodiments, it will be evident that various modifications and changes may be made to these embodiments without departing from the broader spirit and scope of the various embodiments.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

I claim:

1. A device to provide protection and comfort from bright hot sunshine in large open area by matching shading unit positions to get shade pattern on ground corresponding to pattern of presence of persons to be shaded, with the devise comprising:
a) plurality of shading unit, support for the shading unit, drive for shading unit, support and drive cables and support tower;
b) plurality of camera on gimbal mounting to detect and capture location of person and image of shading unit for enabling wind management;
c) plurality of computer to control drive unit of shading units, display and control consoles for manual control and predict movement of person.

2. The device as claimed in claim 1:
wherein the shading unit comprises one of at least plastic film, and plastic film reinforced with fabric, and one of fabric cloth, and of paper coated with plastic, and one of rubber sheet, with a skeletal frame to provide shape, the plastic film being one of continuous film, one of single layer and one of being split into double layer and one with surface of shading unit being made of ribbons and said ribbons with flexible rubber thread at end to allow flexion with wind and to allow free flow of air for aerodynamic management of shading unit from wind and wherein the above claimed film having ultra violet absorption chemicals where partial shading is required, and wherein the shading unit having slots with flaps and control flaps on frame for control when subjected to wind force and wherein shading unit is provided with wind control cable.

3. The device as claimed in claim 1:
wherein the support for the shading unit is by at least one of support cables held by towers with cable being at least one of nylon and one of kevlar, one of carbon fiber and one of high strength plastic and one of metal, with support cables forming border having pulleys for drive cables.

4. The device as claimed in claim 1:
wherein the support for the shading unit as claimed in claim 1, is at least by cantilever arm held on one of tower and one of cantilever held on supporting cable and wherein cantilever arm is rotated by one of electric motor and one of pneumatic motor and wherein each tower having one and having multiple arms and shading units

5. The device as claimed in claim 1:
wherein the support for the shading unit as claimed in claim 1 is at least by the lift force of a set of propellers driven by electric motors to keep the shading unit floating in air at great height and provide drive for movement of shading unit, and supported by hydrogen filled rubber balloon to add buoyancy and lift to the shading unit and wherein the propellers direction of rotation, angular speed and tilt, being controlled by on board micro controller under the control of computer with interface being one of wire and one of wireless radio control.

6. The device as claimed in claim 1:
wherein the drive for shading unit is at least by cable drive, cable being supporting cable itself and wherein drive is one by separate drive cable which greatly prevents cable entanglement, with drive force for cable provided by at least one of electric motor on ground, being one of alternating current, one of direct current and one of stepper motor, with driving shaft coupled to spools, with coupling controlled by clutch which is select either to wind or unwind cable and stabilized by brake, as selected by computer.

7. The device as claimed in claim 1:
wherein the drive for shading unit is at least by on board electric motor on shading unit which drives the spool with cable that enables movement based on winding up of cable to produce the required pull force and wherein drive by one of friction roller griping and turning on support cable driven by the onboard electric motor and wherein control of said on board electric motor is by on board microprocessor having one of radio receiver for control interface and one by interface cable wire, with computer on ground, to properly place the shading unit in required position and with electric power supplied by cable wire.

8. The device as claimed in claim 1:
wherein the drive for the shading unit is at least by pneumatic means by compressed air jets through nozzles for forward and backward movement, controlled by valves operated by instruction from computer.

9. The device as claimed in claim 1:
wherein the camera unit mounted on gimbal is oriented to fix reference coordinated and forming grid map, capture the location coordinates of person to be shaded as point on x and y axis corresponding to place of persons presence, capture the movement of person for direction and velocity vector calculation by computer and capture image of shading unit for correct positioning feedback and aerodynamic control by wind control cables and wherein the camera captures shadow image of one of tower to calculate angle of incidence of sun rays and sun position and wherein each camera covers a selected sector of the area involved.

10. The device as claimed in claim 1:
wherein the computer using program instructions, matches the shade pattern with the pattern of presence of person to be shaded, by analyses image from camera to detect by edge, contrast and tag mark and locate the presence of person as x-y coordinated and prediction of next move by one of extrapolation based on previous move direction, velocity vector and ball movement in game, past movement data pattern from data base, select the required shading unit using person coordinates and calculate its required position coordinated to give shade corresponding to the position of person taking into account angle of light incidence from sun and height of shading unit, which is matching the shade pattern with pattern of persons presence and keeping anticipated next position of shading unit ready by calculation.

11. The device as claimed in claim 1:
wherein computer calculates suns position and sun light incident angle based on camera image of towers shadow, and wherein computer controls image display on monitor with console and joy stick used to move cursor pointer to enable manual prediction of movement of person and manual control of shading unit movement, and wherein the computer controls drive cables by controlling the winding and unwinding of drive cables and wind control cables by providing signal to actuate or de actuate clutch and brake of spool with proper timing in order to get required position coordinates of shading unit, provide drive pulse signal to stepper motors, control signal to cantilever arm rotation motor and its shading unit drive, analyses shading unit image for change in image shape corresponding to wind effect and take data of wind velocity and cable tension sensors and activate or de activate clutch and brake of wind control cable drive and wherein interface with computer is by one of wire and one of wireless radio control.

12. The device as claimed in claim 1:
wherein the support tower as claimed in claim 1 is at least one of tower fixed firmly to ground and one of floating tower with anchorage to provide shade in beaches, with tower having floating platform in the sea and with tower carrying arm on which support cable is attached and wherein tower is mounted on wheels for use in road construction for enabling mobility of the shading device, and wherein tower with cantilever arm is fixed on buildings to shade to persons below on ground.

13. The device as claimed in claim 1 having further addition to enhance comfort to the shaded person by applying pulsed cold compressed air jets in area of persons presence, with addition comprising:
plurality of air cooler and compressor, rotating and non rotating popup nozzle popped up and down by solenoid drive, rotating and non rotating fixed nozzle, valves actuated by solenoid drive, pipelines on surface and pipe lines buried under ground.

14. The device as claimed in claim 13:
wherein nozzles connected to buried and surface pipes to supply cold air from air cooler unit and compressor is used to direct cold air jet to cool only the local area where person is present and wherein rotating popup nozzle and rotating fixed nozzle is rotated by stepper motor in a axis perpendicular to ground and another stepper motor in a axis parallel to ground to direct the jet at person and wherein cover lid to is provided to popup nozzle to avoid obstruction and safety of nozzle and person.

15. The device as claimed in claim 13:
wherein cold air jet from nozzle is controlled by computers as claimed in claim 10 using data of persons presence to select the required nozzle to operate and control the operation of popup nozzle at correct time and turn the nozzle in the direction of the person present and actuate valves to apply cool air jet in pulsed manner to locally cool area of presence of person.

16. The device as claimed in claim 1:
wherein person to be shaded as claimed in claim 1 also refers to animals and objects to be protected from sun and wherein shading device is used for shading and comfort of players in stadium, horses and animals in race course, shading recreating people on beach in hot climates, construction workers in building by using one of cantilever support based shading unit on building, roads and towers in sea rigs and large ship platform, agriculture and farm workers on land.

17. The device as claimed in claim 1:
wherein cables have color coding with connector sockets also color coded to enable easy assembly and correct attachment of drive cables to its correct drive spool, as large number of cables are involved.

18. A method of shading people in large open area at low cost and low energy consumption, using shading units of small size being a few times more than size of person shaded, held at large height without obstruction to view, by matching shading unit position to get shade pattern of small required area on ground corresponding to pattern of presence of persons to be shaded with said pattern of presence of person captured as image by camera on gimbal and image of shading units captured by camera on gimbal as feedback to enable correct positioning of shading unit subjected to wind at large heights.

19. A device to provide protection and comfort from bright hot sunshine in large open area and locally cool the place of persons presence thereby prevent health hazards of bright sun shine like skin cancer and allergy and avoid discomfort of work and play, at low infrastructure cost, by matching shading unit positions to get shade pattern on ground corresponding to pattern of presence of persons to be shaded, with the devise comprising:
a) Plurality of shading unit, drive for shading unit, support cables and support tower, cantilever arm holding the shading unit near periphery;
b) Plurality of camera on gimbal mounting to detect and capture location of person and image of shading unit for wind management;
c) Plurality of computer to control drive unit of shading units, display and control consoles for manual control and predict movement of person, control directed cold air injection and popup and pop down of air discharge nozzle;
d) Plurality of air cooler and compressor, popup and fixed rotating nozzle with solenoid controls and valves supplied with air through pipelines on surface and buried under ground.
